(19) United States
(12) Patent Application Publication
(10) Pub. No.: US 2026/0143421 A1
(43) Pub. Date: May 21, 2026

(54) COMMUNICATION CONTROL SYSTEM, COMMUNICATION CONTROL METHOD, AND NON-TRANSITORY STORAGE MEDIUM

(71) Applicant: TOYOTA JIDOSHA KABUSHIKI KAISHA, Toyota-shi (JP)

(72) Inventors: Kazuhito ESHIMA, Toyota-shi (JP); Hidenobu KINUGASA, Nagoya-shi (JP); Takahiro YAMAMOTO, Toyota-shi (JP); Tatsuya SUGANO, Seto-shi (JP)

(73) Assignee: TOYOTA JIDOSHA KABUSHIKI KAISHA, Toyota-shi (JP)

(21) Appl. No.: 19/370,665

(22) Filed: Oct. 27, 2025

(30) Foreign Application Priority Data
Nov. 15, 2024 (JP) 2024-199807

(51) Int. Cl. H04W 48/20; H04B 17/20; H04B 17/27

(52) U.S. Cl. CPC H04W 48/20; H04B 17/253; H04B 17/27

(57) ABSTRACT

A communication control system acquires information on a radio wave intensity distribution of each of a plurality of access points and calculates a score of each of the access points at a target position on a traveling path of a vehicle. The score of each of the access points includes a first score and a second score. The first score becomes higher as radio wave intensity at the target position becomes stronger. The second score becomes higher as continuity of an upward trend of radio wave intensity along the traveling path beyond the target position becomes higher. The communication control system selects a target access point to which the vehicle at the target position is to be connected among the plurality of access points based on the score of each of the access points.

### CROSS-REFERENCE TO RELATED APPLICATION

This application claims priority to Japanese Patent Application No. 2024-199807 filed on November 15, 2024. The disclosure of the above-identified application, including the specification, drawings, and claims, is incorporated by reference herein in its entirety.

### BACKGROUND

### 1. Technical Field

The present disclosure relates to a communication control technology to be applied to a vehicle to be connected to an access point of a wireless communication network. Specifically, the present disclosure relates to a communication control system, a communication control method, and a non-transitory storage medium.

### 2. Description of Related Art

Japanese Unexamined Patent Application Publication No. 2018-77652 (JP 2018-77652 A) discloses a vehicle driving support system. The vehicle driving support system includes a communication unit that performs wireless communication, and a driving control unit that performs automated driving control based on information acquired via the communication unit.

### SUMMARY

A vehicle to be connected to an access point of a wireless communication network in a predetermined area will be considered. A target access point is one of a plurality of access points provided in the predetermined area, to which the vehicle is to be connected. When the vehicle travels in the predetermined area, the vehicle performs wireless communication while switching the target access point. However, wireless communication is interrupted for a moment at a switching timing of the target access point, and thus, it is desired to prevent the target access point from being switched frequently more than necessary.

A first aspect relates to a communication control system.

The communication control system is to be applied to a vehicle that travels in a predetermined area in which a plurality of access points is provided.

The communication control system includes one or more processors.

The one or more processors are configured to

acquire information on a radio wave intensity distribution of each of the plurality of access points,

acquire information on a traveling path of the vehicle in the predetermined area,

calculate a score of each of the access points at a target position on the traveling path based on the acquired information on the radio wave intensity distribution and the acquired information on the traveling path, and

select a target access point to which the vehicle at the target position is to be connected among the plurality of access points based on the calculated score of each of the access points.

The calculated score of each of the access points includes at least a first score and a second score.

The first score becomes higher as radio wave intensity at the target position becomes stronger.

The second score becomes higher as continuity of an upward trend of radio wave intensity along the traveling path beyond the target position becomes higher.

A second aspect relates to a communication control method to be executed by a computer.

The communication control method is to be applied to a vehicle that travels in a predetermined area in which a plurality of access points is provided.

The communication control method includes

acquiring information on a radio wave intensity distribution of each of the plurality of access points,

acquiring information on a traveling path of the vehicle in the predetermined area,

calculating a score of each of the access points at a target position on the traveling path based on the acquired information on the radio wave intensity distribution and the acquired information on the traveling path, and

selecting a target access point to which the vehicle at the target position is to be connected among the plurality of access points based on the score of each of the access points.

The score of each of the access points includes at least a first score and a second score.

The first score becomes higher as radio wave intensity at the target position becomes stronger.

The second score becomes higher as continuity of an upward trend of radio wave intensity along the traveling path beyond the target position becomes higher.

A third aspect relates to non-transitory storage medium storing instructions that are executable by one or more processors and that cause the one or more processors to perform functions including:

acquiring information on a radio wave intensity distribution of each of a plurality of access points;

acquiring information on a traveling path of a vehicle in the predetermined area;

calculating a score of each of the access points at a target position on the traveling path based on the acquired information on the radio wave intensity distribution and the acquired information on the traveling path; and

selecting a target access point to which the vehicle at the target position is to be connected among the plurality of access points based on the calculated score of each of the access points.

The calculated score of each of the access points includes at least a first score and a second score.

The first score becomes higher as radio wave intensity at the target position becomes stronger.

The second score becomes higher as continuity of an upward trend of radio wave intensity along the traveling path beyond the target position becomes higher.

According to the present disclosure, the score of each of the access points at the target position is calculated also in consideration of the "continuity of the upward trend of the radio wave intensity beyond the target position" as well as the "radio wave intensity at the target position". Then, the target access point is selected based on the score calculated in this manner. By this means, the access point with the higher continuity of the upward trend of the radio wave intensity beyond the target position is more likely to be selected as the target access point. This results in suppressing frequent switching of the target access point in a short period of time. In other words, the target access point is prevented from being switched frequently more than necessary.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual diagram for describing an example of vehicle control in a predetermined area;

FIG. 2 is a conceptual diagram for describing access points provided in the predetermined area;

FIG. 3 is a conceptual diagram for describing outline of an information processing system that executes communication-related processing;

FIG. 4 is a conceptual diagram for describing outline of a communication control function of the information processing system (communication control system);

FIG. 5 is a conceptual diagram for describing outline of a path determination function of the information processing system (path determination system);

FIG. 6 is a conceptual diagram for describing a first example of the communication-related processing;

FIG. 7 is a block diagram illustrating a functional configuration example regarding the first example of the communication-related processing;

FIG. 8 is a conceptual diagram for describing a second example of the communication-related processing;

FIG. 9 is a conceptual diagram for describing an example of upward trend continuity in the second example of the communication-related processing;

FIG. 10 is a block diagram illustrating a functional configuration example regarding the second example of the communication-related processing;

FIG. 11 is a conceptual diagram for describing a comparative example;

FIG. 12 is a conceptual diagram for describing a third example of the communication-related processing;

FIG. 13 is a block diagram illustrating a functional configuration example regarding the third example of the communication-related processing;

FIG. 14 is a block diagram illustrating a functional configuration example regarding a fourth example of the communication-related processing;

FIG. 15 is a block diagram illustrating a functional configuration example regarding a fifth example of the communication-related processing;

FIG. 16 is a block diagram illustrating a functional configuration example regarding a sixth example of the communication-related processing;

FIG. 17 is a block diagram illustrating a functional configuration example regarding a seventh example of the communication-related processing;

FIG. 18 is a block diagram illustrating a configuration example of an in-vehicle system;

FIG. 19 is a block diagram illustrating a configuration example of a management system; and

FIG. 20 is a block diagram illustrating a configuration example of the information processing system.

### DETAILED DESCRIPTION OF EMBODIMENTS

An embodiment of the present disclosure will be described with reference to the accompanying drawings.

### 1. Vehicle Control in Predetermined Area

Control of a vehicle 1 in a predetermined area AR will be considered. Examples of the predetermined area AR can include a parking lot, a factory, a site of a facility, one town (smart city), and the like. In the predetermined area AR, the vehicle 1 is controlled to travel to a set destination. The vehicle 1 may be an automated driving vehicle.

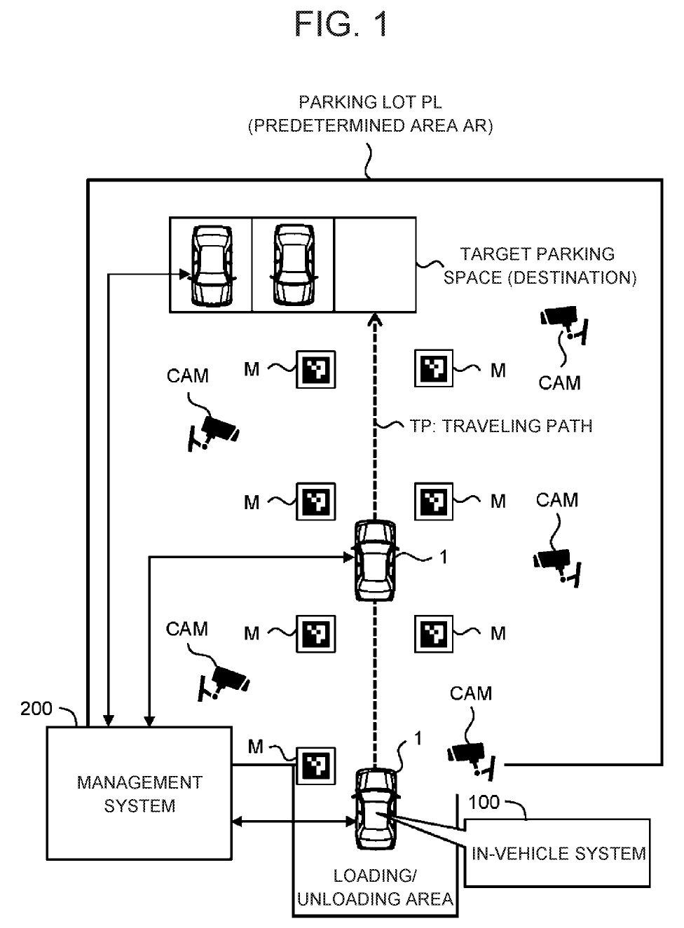

FIG. 1 is a conceptual diagram for describing an example of control of the vehicle 1 in the predetermined area AR. In the example illustrated in FIG. 1, the predetermined area AR is a parking lot PL. The parking lot PL provides an automated valet parking (AVP) service. The vehicle 1 has a function of performing automated valet parking and can autonomously travel at least within the parking lot PL.

An in-vehicle system 100 is mounted on the vehicle 1 and controls the vehicle 1. Specifically, the in-vehicle system 100 recognizes a condition around the vehicle 1 using a recognition sensor (for example, a camera) mounted on the vehicle 1. The in-vehicle system 100 causes the vehicle 1 to safely travel while recognizing the condition around the vehicle 1. A plurality of markers M (landmarks) may be provided within the parking lot PL. The markers M are used to guide the vehicle 1 within the parking lot PL. For example, the in-vehicle system 100 acquires an image of a circumference using the camera and recognizes the markers M based on the image. Then, the in-vehicle system 100 performs localization processing that estimates a position of the vehicle 1 in the parking lot PL with high accuracy based on the recognition result of the markers M. The in-vehicle system 100 causes the vehicle 1 to autonomously travel within the parking lot PL based on the estimated vehicle position.

A management system 200, which is a system that manages the parking lot PL (predetermined area AR) and automated valet parking, is arranged outside the vehicle 1. The management system 200 can perform communication with each vehicle 1 within the parking lot PL. For example, the management system 200 performs communication with each vehicle 1 within the parking lot PL via a wireless LAN. The management system 200 may remotely operate each vehicle 1 within the parking lot PL.

One or more infrastructure cameras CAM may be provided within the parking lot PL. The infrastructure camera CAM captures an image of the parking lot PL and acquires the image indicating a condition of the parking lot PL. The management system 200 performs communication with the infrastructure camera CAM to acquire the image captured by the infrastructure camera CAM. The management system 200 detects the vehicle 1 in the image by analyzing the image. Further, the management system 200 estimates a position of the vehicle 1 in the image. Still further, the management system 200 manages the vehicle 1 within the parking lot PL based on the position of the vehicle 1. The management system 200 may provide position information of the vehicle 1 to the vehicle 1. The in-vehicle system 100 of the vehicle 1 may cause the vehicle 1 to autonomously travel within the parking lot PL based on the position information provided from the management system 200.

Loading processing is as follows. The vehicle 1 stops in a loading area. The management system 200 allocates an available parking space to the vehicle 1. The allocated available parking space becomes a target parking space, that is, a destination for the vehicle 1 upon loading. Further, the management system 200 sets a target trajectory (traveling path TP) from the loading area to the target parking space in the parking lot PL. The in-vehicle system 100 acquires information on the target trajectory to the target parking space. The management system 200 issues a loading instruction to the in-vehicle system 100. In response to the loading instruction, the in-vehicle system 100 causes the vehicle 1 to travel to the target parking space in accordance with the target trajectory. In other words, the in-vehicle system 100 controls the vehicle 1 to follow the target trajectory based on the vehicle position. Then, the in-vehicle system 100 causes the vehicle 1 to be parked at the target parking space.

Unloading processing is as follows. Upon unloading, a designated unloading area becomes a destination for the vehicle 1. The management system 200 sets a target trajectory (traveling path TP) from the parking space to the unloading area in the parking lot PL. The in-vehicle system 100 acquires information on the target trajectory to the unloading area. The management system 200 issues an unloading instruction to the in-vehicle system 100. In response to the unloading instruction, the in-vehicle system 100 causes the vehicle 1 to travel to the unloading area in accordance with the target trajectory. In other words, the in-vehicle system 100 controls the vehicle 1 to follow the target trajectory based on the vehicle position. Then, the in-vehicle system 100 causes the vehicle 1 to stop in the unloading area.

### 2. Access Points in Predetermined Area and Communication-Related Processing

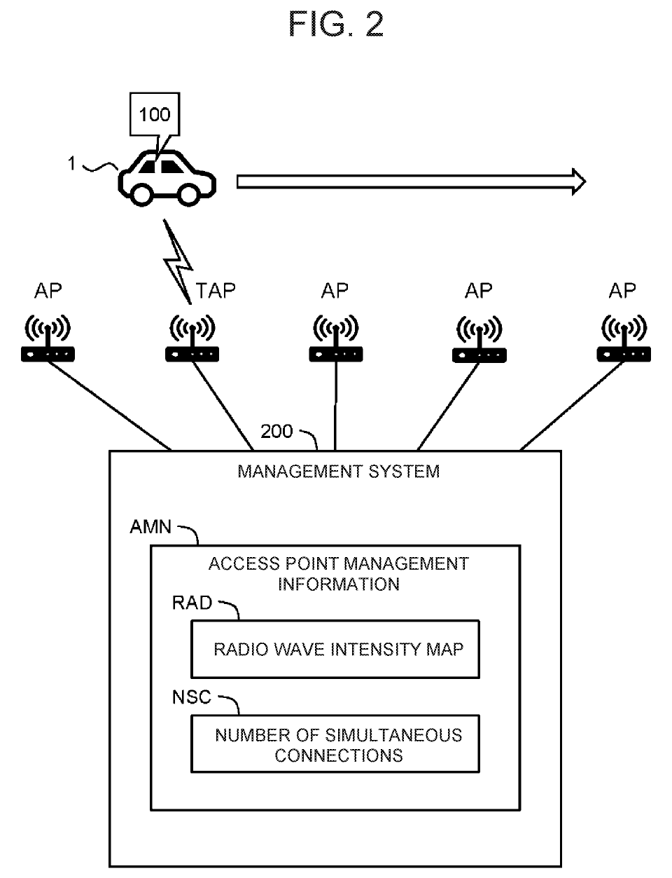

FIG. 2 is a conceptual diagram for describing access points AP provided in the predetermined area AR. The vehicle 1 (in-vehicle system 100) within the predetermined area AR performs communication with the management system 200 via a wireless communication network. The wireless communication network is a wireless local area network (LAN). Thus, a plurality of access points AP for connecting to the wireless LAN is provided within the predetermined area AR.

A target access point TAP is one of the plurality of access points AP provided in the predetermined area AR, to which the vehicle 1 (in-vehicle system 100) is to be connected. The vehicle 1 (in-vehicle system 100) connects to the target access point TAP and performs wireless communication with the target access point TAP, thereby performing communication with the management system 200 by utilizing the wireless LAN. The vehicle 1 (in-vehicle system 100) may perform vehicle traveling control by communicating various kinds of information with the management system 200. The vehicle 1 (in-vehicle system 100) travels in the predetermined area AR while switching the target access point TAP to be connected.

The management system 200 that manages the predetermined area AR holds access point management information AMN for managing the access points AP within the predetermined area AR.

The access point management information AMN includes a radio wave intensity map RAD. The radio wave intensity map RAD includes information on the radio wave intensity distribution of each of the plurality of access points AP within the predetermined area AR. For example, the radio wave intensity map RAD indicates identification information, a position at which the access point AP is provided within the predetermined area AR, and the radio wave intensity distribution within the predetermined area AR for each access point AP.

For example, the radio wave intensity map RAD provides a "static" radio wave intensity distribution for each access point AP. The static radio wave intensity distribution of the access point AP is determined based on the position at which the access point AP is provided and performance of the access point AP. The performance of the access point AP is specified by a model, radio wave output capability, a radio frequency, and the like. Such a static radio wave intensity distribution can be obtained in advance based on the position at which the access point AP is provided and the performance of the access point AP. Once the radio wave intensity map RAD is created, the same radio wave intensity map RAD can be continuously used. However, when the access point AP is replaced, the radio wave intensity map RAD is updated.

As another example, the radio wave intensity map RAD may provide a "dynamic" radio wave intensity distribution for each access point AP. More specifically, the radio wave intensity distribution can dynamically fluctuate also by a distribution of moving bodies (for example, other vehicles) within the predetermined area AR. Thus, the management system 200 may calculate a dynamic radio wave intensity distribution of each access point AP in real time in consideration of the distribution of moving bodies in the predetermined area AR. In other words, the management system 200 may calculate a dynamic radio wave intensity distribution regarding the access point AP in real time based on the distribution of the moving bodies in the predetermined area AR in addition to the position at which the access point AP is provided and the performance of the access point AP. In particular, in a case of the parking lot PL exemplified in FIG. 1 described above, the management system 200 that manages automated valet parking in the parking lot PL accurately grasps a current distribution (current positions) of all the vehicles 1 within the parking lot PL. Thus, the management system 200 can calculate the dynamic radio wave intensity distribution for each access point AP in real time.

The access point management information AMN may include the number of simultaneous connections NSC of each of the plurality of access points AP within the predetermined area AR. For example, the management system 200 performs communication with each access point AP to acquire information on the number of simultaneous connections NSC from each access point AP in real time. The management system 200 manages the information on the number of simultaneous connections NSC collected from each access point AP.

According to the present embodiment, various kinds of processing related to communication using the access point AP is executed based on the access point management information AMN. Hereinafter, the processing related to communication using the access point AP will be referred to as "communication-related processing".

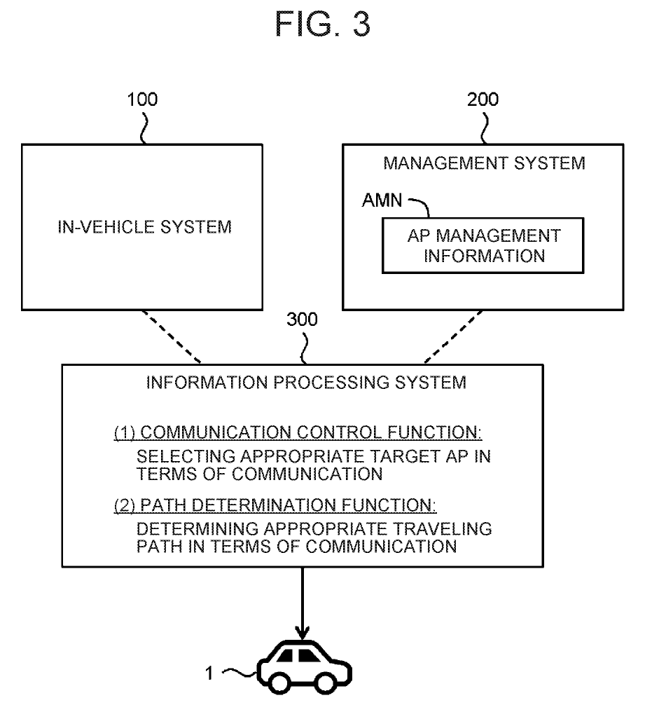

FIG. 3 is a conceptual diagram for describing outline of an information processing system 300 that executes the communication-related processing. The information processing system 300 is applied to the vehicle 1. "Applied to the vehicle 1" means that it is only necessary that a result of the communication-related processing executed by the information processing system 300 be reflected in at least the vehicle 1. For example, the information processing system 300 is included in the in-vehicle system 100. As another example, the information processing system 300 may be included in the management system 200 that can perform communication with the in-vehicle system 100. As still another example, the information processing system 300 may be distributed into the in-vehicle system 100 and the management system 200. As yet another example, the information processing system 300 may be a system which is different from but can perform communication with the in-vehicle system 100 and the management system 200. In either case, the in-vehicle system 100, the management system 200, and the information processing system 300 are configured to be able to share the same information. The information processing system 300 acquires the access point management information AMN from the management system 200. Further, the information processing system 300 executes the communication-related processing based on the access point management information AMN. Then, the information processing system 300 shares a result of the communication-related processing with the in-vehicle system 100.

One example of the communication-related processing is "communication control processing" of controlling communication by selecting an appropriate target access point TAP in terms of communication. In other words, the information processing system 300 has a "communication control function" of controlling communication by selecting an appropriate target access point TAP in terms of communication. The information processing system 300 having such a communication control function can be also referred to as a "communication control system".

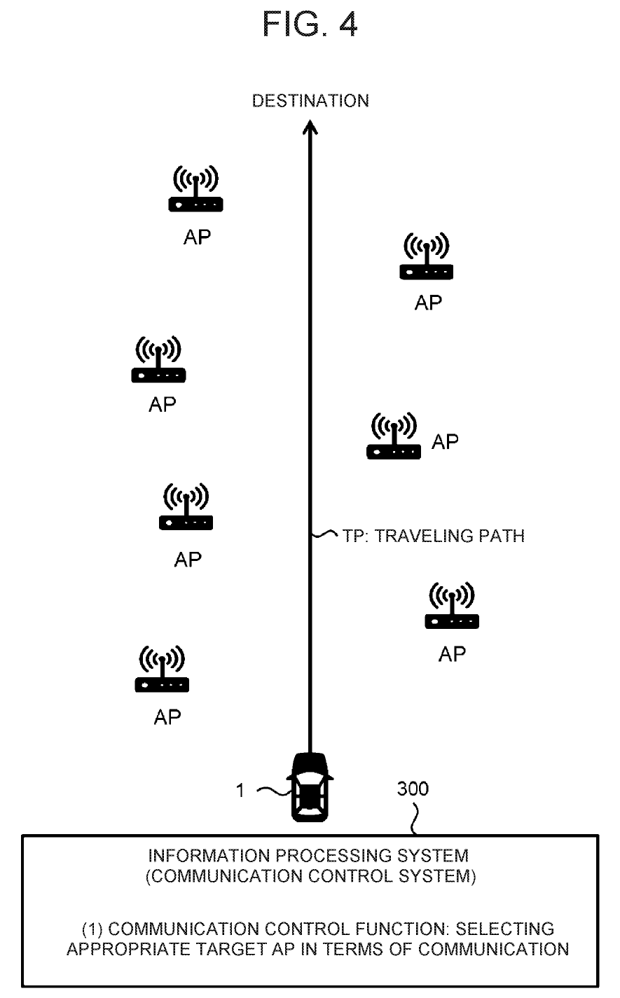

FIG. 4 is a conceptual diagram for describing outline of the communication control function of the information processing system 300 (communication control system). A plurality of access points AP is provided in the predetermined area AR. Further, a traveling path TP of the vehicle 1 in the predetermined area AR is provided. The traveling path TP is, for example, set by the management system 200. The communication control function selects the target access point TAP to which the vehicle 1 at the target position on the traveling path TP should be connected among the plurality of access points AP. For example, the target position on the traveling path TP is a current position of the vehicle 1. In this case, the communication control function selects the target access point TAP to which the vehicle 1 should be connected in real time. As another example, the target position on the traveling path TP may be an arbitrary position. In this case, the target access point TAP to which the vehicle 1 should be connected on the traveling path TP can be planned in advance.

Another example of the communication-related processing is "path determination processing" of determining an appropriate traveling path TP in terms of communication. In other words, the information processing system 300 has a "path determination function" of determining an appropriate traveling path TP in terms of communication. The information processing system 300 having such a path determination function can be also referred to as a "path determination system".

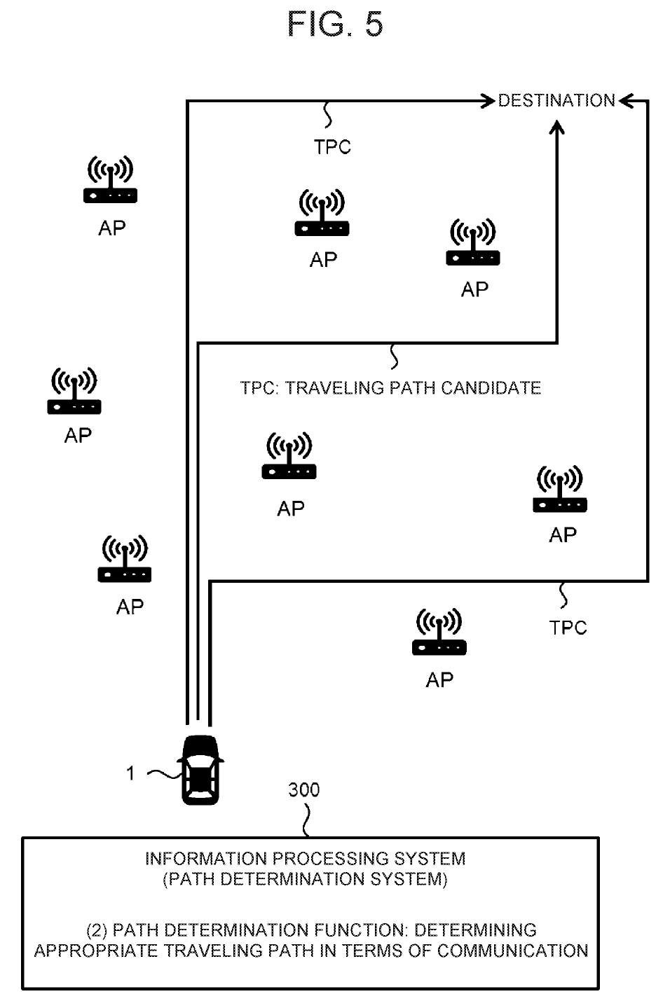

FIG. 5 is a conceptual diagram for describing outline of the path determination function of the information processing system 300 (path determination system). A plurality of access points AP is provided in the predetermined area AR. Further, a traveling path candidate TPC that is a candidate for the traveling path TP of the vehicle 1 in the predetermined area AR is provided. In particular, a plurality of the traveling path candidates TPC is provided. The plurality of traveling path candidates TPC is, for example, set by the management system 200. When there are a number of possible traveling path candidates TPC to a destination, only traveling path candidates TPC for which distances to the destination are less than a threshold may be selected in advance. The path determination function determines (selects) an appropriate traveling path TP among the plurality of traveling path candidates TPC in terms of communication.

### 3. Various Examples of Communication-Related Processing

Various examples of the communication-related processing by the information processing system 300 according to the present embodiment will be described in detail below. First to fourth examples are examples of the communication control processing by the communication control system illustrated in FIG. 4 above. Fifth to seventh examples are examples of the path determination processing by the path determination system illustrated in FIG. 5 above.

### 3-1. First Example

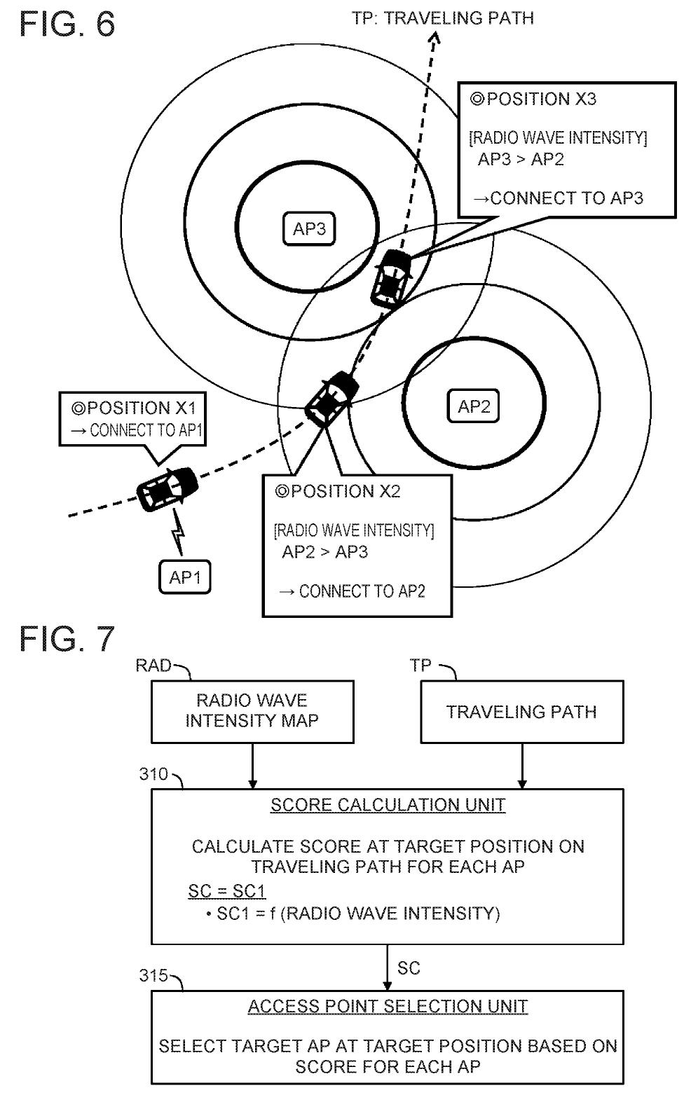

FIG. 6 is a conceptual diagram for describing the first example of the communication-related processing. FIG. 6 illustrates a certain vehicle 1, a traveling path TP of the vehicle 1, and access points AP1, AP2, AP3. A radio wave intensity distribution is also indicated for each of the access points AP2, AP3. A circle around each access point AP expresses the radio wave intensity distribution, and a thicker line of the circle means stronger radio wave intensity.

The vehicle 1 travels along the traveling path TP. The vehicle 1 is connected to the access point AP1 at a position X1 on the traveling path TP. Then, the radio wave intensity of the access point AP2 becomes stronger on the traveling path TP. At a position X2 on the traveling path TP, the vehicle 1 switches the target access point TAP from the access point AP1 to the access point AP2. At the position X2, the radio wave intensity of the access point AP2 is stronger than the radio wave intensity of the access point AP3. Then, at a position X3 on the traveling path TP, the radio wave intensity of the access point AP3 becomes stronger than the radio wave intensity of the access point AP2. The vehicle 1 switches the target access point TAP from the access point AP2 to the access point AP3. In this manner, in the first example, the target access point TAP is selected in consideration of the radio wave intensity.

FIG. 7 is a block diagram illustrating a functional configuration example regarding the first example of the communication-related processing. The information processing system 300 (communication control system) includes a score calculation unit 310 and an access point selection unit 315.

The score calculation unit 310 acquires the radio wave intensity map RAD and information on the traveling path TP. The radio wave intensity map RAD is included in the access point management information AMN and can be obtained from the management system 200. The traveling path TP is also set by the management system 200 and can be obtained from the management system 200. The score calculation unit 310 calculates a score SC of each access point AP at the target position on the traveling path TP based on the radio wave intensity map RAD and the traveling path TP. For example, the target position is a current position of the vehicle 1. In this case, the score calculation unit 310 calculates the score SC of each access point AP at the current position of the vehicle 1. As another example, the target position may be an arbitrary position. In this case, the score calculation unit 310 can calculate the score SC of each access point AP at an arbitrary position on the traveling path TP.

In the first example, the score SC of each access point AP at the target position includes only a first score SC1 (SC = SC1). The first score SC1 is expressed with a function (f) of the radio wave intensity of each access point AP at the target position. The radio wave intensity of each access point AP at the target position can be obtained from the radio wave intensity map RAD. As the radio wave intensity at the target position becomes stronger, the first score SC1 becomes higher. In other words, as the radio wave intensity at the target position becomes stronger, the score SC becomes higher.

The access point selection unit 315 acquires the score SC of each access point AP at the target position calculated in this manner. Then, the access point selection unit 315 selects the target access point TAP to which the vehicle 1 at the target position should be connected among the plurality of access points AP based on the score SC. Typically, the access point selection unit 315 selects the access point AP with the highest score SC among the plurality of access points AP as the target access point TAP.

### 3-2. Second Example

Concerning the first example described above, there is a possible problem as described below. The problem is that there is a possibility that the target access point TAP may be frequently switched in a short period of time. For example, in the example illustrated in FIG. 6 above, the target access point TAP is switched from the access point AP1 to the access point AP2, and immediately after that, switched from the access point AP2 to the access point AP3. A period during which the target access point TAP is the access point AP2 is very short. In other words, the target access point TAP is frequently switched during a short period of time. However, wireless communication is interrupted for a moment at a switching timing of the target access point TAP. In terms of reduction in risk, it is desirable to prevent the target access point TAP from being switched frequently more than necessary.

In the second example, a method for solving the above-described problem will be proposed.

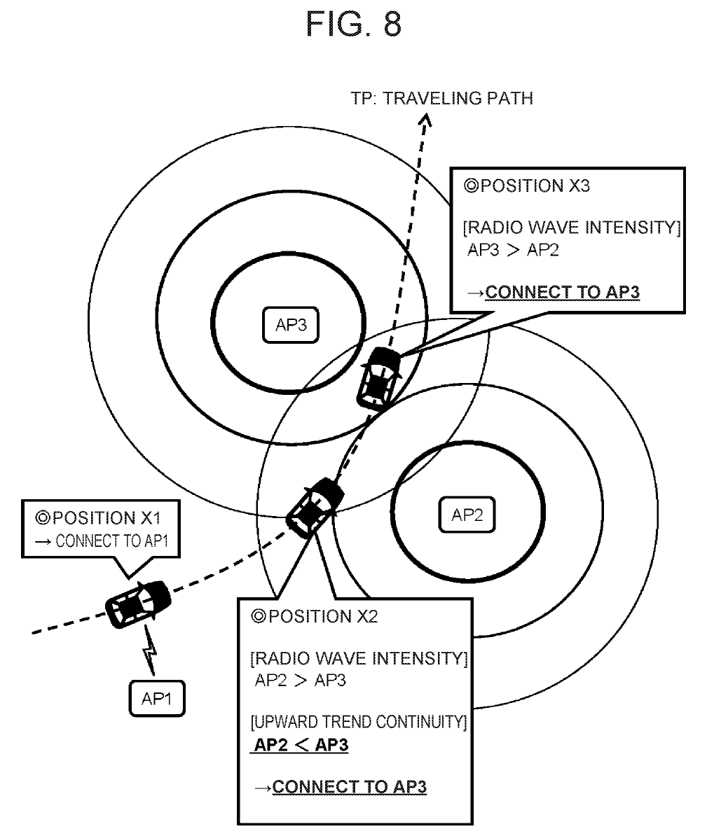

FIG. 8 is a conceptual diagram for describing the second example of the communication-related processing. Description overlapping with the description of FIG. 6 above will be omitted as appropriate. At the position X2 on the traveling path TP, the radio wave intensity of the access point AP2 is stronger than the radio wave intensity of the access point AP3. However, considering the traveling path TP beyond the position X2, while the radio wave intensity of the access point AP2 just keeps decreasing, the radio wave intensity of the access point AP3 increases for a while. In other words, it can be understood that the access point AP3 can be a possible target access point TAP for a while beyond the position X2. Thus, in the second example, it can be considered that the vehicle 1 at the position X2 is intentionally not connected to the access point AP2, and instead connected to the access point AP3. In other words, it can be considered that the target access point TAP is switched from the access point AP1 to the access point AP3 while the access point AP2 is skipped. This can suppress a situation where the target access point TAP is frequently switched in a short period of time.

From the above-described viewpoints, according to the second example, the target access point TAP is selected also in consideration of "continuity of an upward trend of the radio wave intensity along the traveling path beyond the target position" as well as the "radio wave intensity at the target position". The "continuity of the upward trend of the radio wave intensity along the traveling path beyond the target position" will be hereinafter referred to as "upward trend continuity CON".

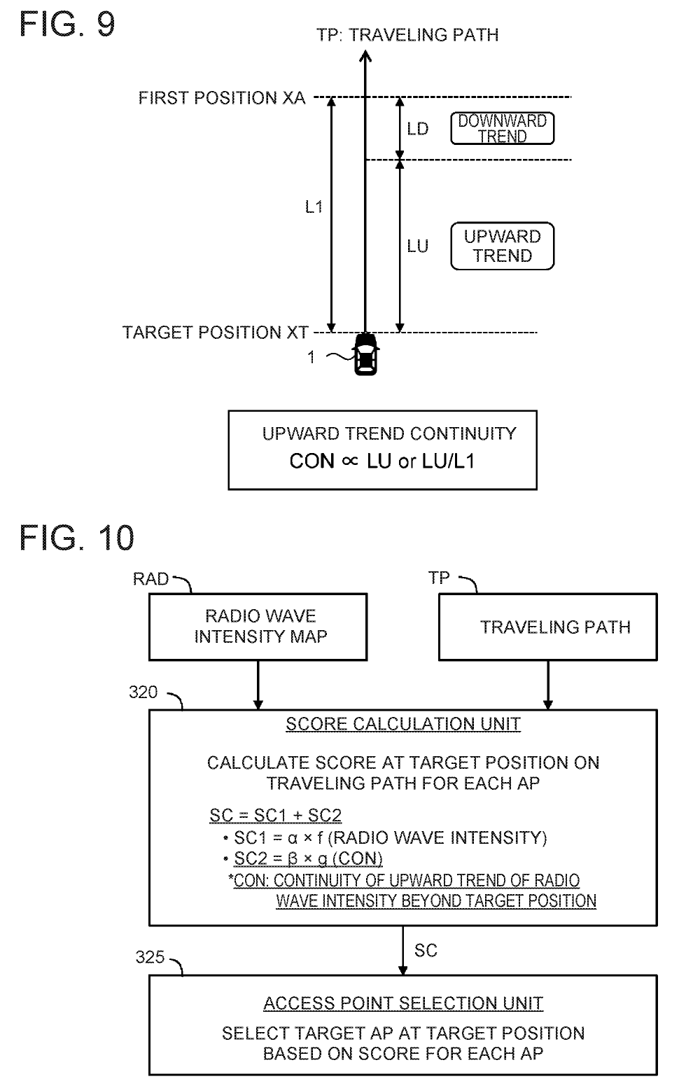

FIG. 9 is a conceptual diagram for describing an example of the upward trend continuity CON. A first position XA is a position located a first distance L1 ahead of the target position XT along the traveling path TP. The first distance L1 may be a fixed distance. Alternatively, the first distance L1 may fluctuate in accordance with a condition. For example, the first distance L1 may increase as a speed of the vehicle 1 becomes higher. A determination range is a range between the target position XT and the first position XA along the traveling path TP. An upward trend distance LU is a sum of distances during which the upward trend of the radio wave intensity continues in the determination range. A downward trend area LD is a sum of distances during which a downward trend of the radio wave intensity continues in the determination range. The upward trend continuity CON is calculated to be higher as the upward trend distance LU becomes longer. Alternatively, the upward trend continuity CON is calculated to be higher as a ratio of the upward trend distance LU with respect to the first distance L1 (LU/L1) becomes higher. In other words, as the upward trend distance LU or the ratio LU/L1 increases, the upward trend continuity CON becomes higher. Such an upward trend continuity CON can be calculated for each access point AP based on the radio wave intensity map RAD and the information on the traveling path TP.

FIG. 10 is a block diagram illustrating a functional configuration example regarding the second example of the communication-related processing. Description overlapping with the description of the above-described first example will be omitted as appropriate. The information processing system 300 (communication control system) includes a score calculation unit 320 and an access point selection unit 325.

The score calculation unit 320 acquires the radio wave intensity map RAD and the information on the traveling path TP. The score calculation unit 320 calculates the score SC of each access point AP at the target position on the traveling path TP based on the radio wave intensity map RAD and the information on the traveling path TP. In the second example, the score SC of each access point AP at the target position includes the first score SC1 and a second score SC2. In other words, the score SC is a sum of the first score SC1 and the second score SC2 (SC = SC1 + SC2).

The first score SC1 is similar to a case of the above-described first example, and is expressed with a function (f) of the radio wave intensity of each access point AP at the target position. As the radio wave intensity at the target position becomes stronger, the first score SC1 becomes higher.

The second score SC2 is expressed with a function (g) of the upward trend continuity CON beyond the target position. The upward trend continuity CON can be calculated based on the radio wave intensity map RAD and the information on the traveling path TP (see FIG. 9). As the upward trend continuity CON becomes higher, the second score SC2 becomes higher.

A weight coefficient α and a weight coefficient β respectively specify a weight of the first score SC1 and a weight of the second score SC2. For example, the weight coefficients α, β are set such that relationships of α + β = 1, 0 < α < 1, and 0 < β < 1 are satisfied. Any setting values may be used for the weight coefficients α, β. When emphasis is placed on the radio wave intensity, a relatively great weight coefficient α is set. On the other hand, when emphasis is placed on reduction in the number of times of switching of the access point, a relatively great weight coefficient β is set.

The access point selection unit 325 acquires the score SC of each access point AP at the target position calculated in this manner. Then, the access point selection unit 325 selects the target access point TAP to which the vehicle 1 at the target position should be connected among the plurality of access points AP based on the score SC. Typically, the access point selection unit 325 selects the access point AP with the highest score SC among the plurality of access points AP as the target access point TAP.

As described above, according to the second example, the score SC of each access point AP at the target position is calculated also in consideration of "continuity of the upward trend of the radio wave intensity beyond the target position" as well as the "radio wave intensity at the target position". Then, the target access point TAP is selected based on the score SC calculated in this manner. Thus, the access point with higher continuity of the upward trend of the radio wave intensity beyond the target position is more likely to be selected as the target access point TAP. This results in suppressing frequent switching of the target access point TAP in a short period of time. In other words, the target access point TAP is prevented from being switched frequently more than necessary. This is preferable in terms of reduction in risk.

### 3-3. Third Example

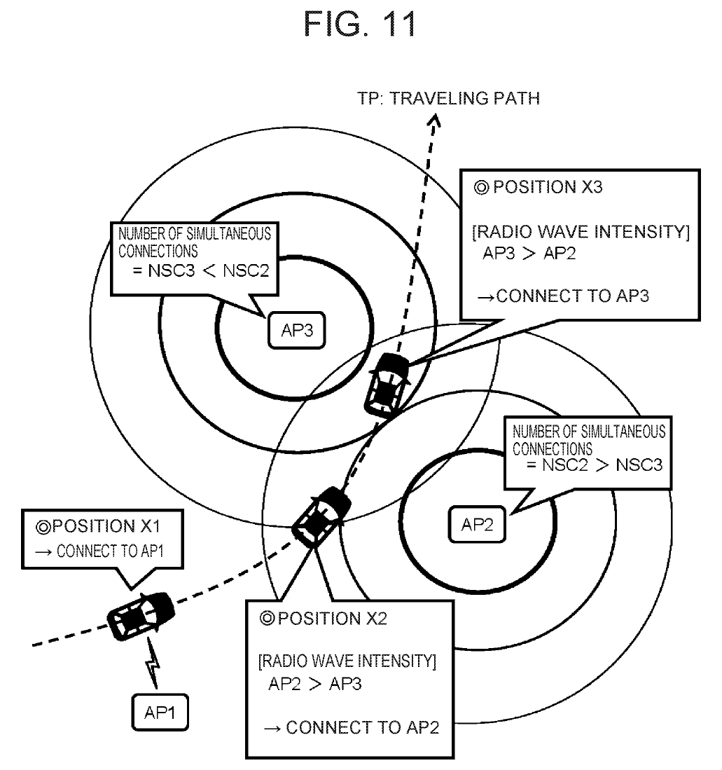

FIG. 11 illustrates a condition that is the same as the condition already described in FIG. 6. At the position X2 on the traveling path TP, the vehicle 1 is connected to the access point AP2. At the position X3 on the traveling path TP, the vehicle 1 is connected to the access point AP3. It is assumed here that the number of simultaneous connections NSC2 to the access point AP2 is larger than the number of simultaneous connections NSC3 to the access point AP3 (NSC2 > NSC3). If the number of simultaneous connections NSC to the access point AP is large, there is a possibility that communication stability may degrade due to decrease in communication speed and increase in communication delay. Thus, connecting to the access point AP2 cannot be necessarily said as an optimal option in terms of communication stability.

Thus, in the third example, the target access point TAP is selected also in consideration of the "number of simultaneous connections NSC" to each access point AP.

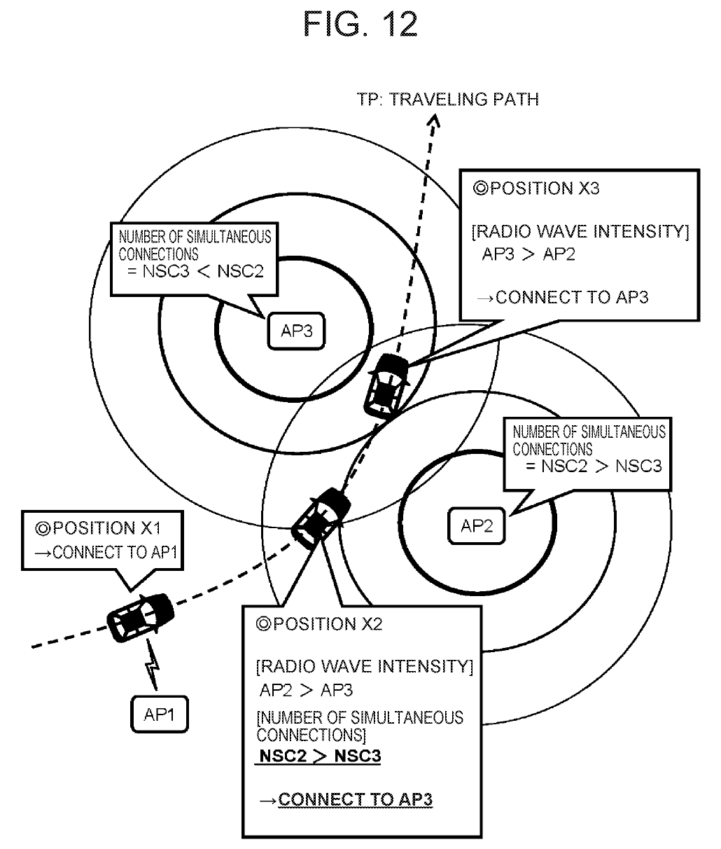

FIG. 12 is a conceptual diagram for describing the third example of the communication-related processing. Description overlapping with the description of FIG. 11 above will be omitted as appropriate. At the position X2 on the traveling path TP, the radio wave intensity of the access point AP2 is stronger than the radio wave intensity of the access point AP3. However, the number of simultaneous connections NSC2 to the access point AP2 is larger than the number of simultaneous connections NSC3 to the access point AP3 (NSC2 > NSC3). Thus, in the third example, it can be considered that the vehicle 1 at the position X2 is intentionally not connected to the access point AP2, and instead connected to the access point AP3. In other words, it can be considered that the target access point TAP is switched from the access point AP1 to the access point AP3 while the access point AP2 is skipped. This can suppress decrease in communication stability.

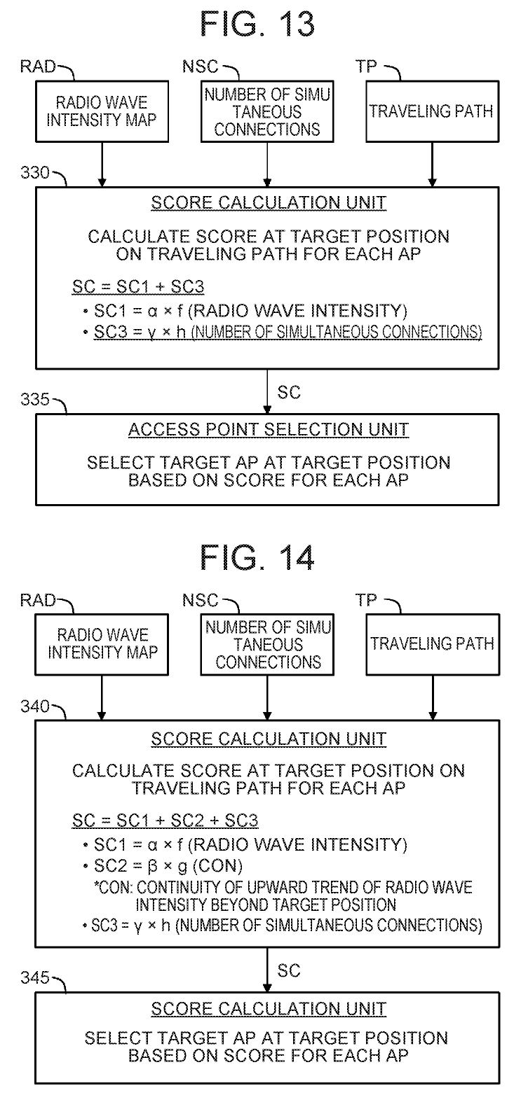

FIG. 13 is a block diagram illustrating a functional configuration example regarding the third example of the communication-related processing. Description overlapping with the description of the above-described first example will be omitted as appropriate. The information processing system 300 (communication control system) includes a score calculation unit 330 and an access point selection unit 335.

The score calculation unit 330 acquires the radio wave intensity map RAD, the number of simultaneous connections NSC, and the information on the traveling path TP. The radio wave intensity map RAD and the number of simultaneous connections NSC are included in the access point management information AMN and can be obtained from the management system 200. The traveling path TP is also set by the management system 200 and can be obtained from the management system 200. The score calculation unit 330 calculates the score SC of each access point AP at the target position on the traveling path TP based on the radio wave intensity map RAD, the number of simultaneous connections NSC, and the information on the traveling path TP. In the third example, the score SC of each access point AP at the target position includes the first score SC1 and a third score SC3. In other words, the score SC is a sum of the first score SC1 and the third score SC3 (SC = SC1 + SC3).

The first score SC1 is similar to the case of the above-described first example and is expressed with a function (f) of the radio wave intensity of each access point AP at the target position. As the radio wave intensity at the target position becomes stronger, the first score SC1 becomes higher.

The third score SC3 is expressed with a function (h) of the number of simultaneous connections NSC to each access point AP. As the number of simultaneous connections NSC becomes smaller, the third score SC3 becomes higher. Inversely, as the number of simultaneous connections NSC becomes larger, the third score SC3 becomes lower.

The weight coefficient α and a weight coefficient γ respectively specify the weight of the first score SC1 and a weight of the third score SC3. For example, the weight coefficients α, γ are set such that relationships of α + γ = 1, 0 < α < 1, and 0 < γ < 1 are satisfied. Any setting values may be used for the weight coefficients α, γ. When emphasis is placed on the radio wave intensity, a relatively great weight coefficient α is set. On the other hand, when emphasis is placed on the number of simultaneous connections NSC, a relatively great weight coefficient γ is set.

The access point selection unit 335 acquires the score SC of each access point AP at the target position calculated in this manner. Then, the access point selection unit 335 selects a target access point TAP to which the vehicle 1 at the target position should be connected among the plurality of access points AP based on the score SC. Typically, the access point selection unit 335 selects the access point AP with the highest score SC among the plurality of access points AP as the target access point TAP.

As described above, according to the third example, the score SC of each access point AP at the target position is calculated also in consideration of the "number of simultaneous connections NSC" as well as the "radio wave intensity at the target position". As the number of simultaneous connections NSC becomes smaller, the score SC becomes higher. Then, the target access point TAP is selected based on the score SC calculated in this manner. By this means, the access point AP with the smaller number of simultaneous connections NSC is more likely to be selected as the target access point TAP. This results in suppressing decrease in communication stability.

### 3-4. Fourth Example

FIG. 14 is a block diagram illustrating a functional configuration example regarding the fourth example of the communication-related processing. The fourth example is a combination of the second example and the third example described above. The information processing system 300 (communication control system) includes a score calculation unit 340 and an access point selection unit 345.

The score calculation unit 340 calculates the score SC of each access point AP at the target position on the traveling path TP based on the radio wave intensity map RAD, the number of simultaneous connections NSC, and the information on the traveling path TP. In the fourth example, the score SC of each access point AP at the target position includes the first score SC1, the second score SC2, and the third score SC3. In other words, the score SC is a sum of the first score SC1, the second score SC2, and the third score SC3 (SC = SC1 + SC2 + SC3). The weight coefficient α, the weight coefficient β, and the weight coefficient γ respectively specify the weight of the first score SC1, the weight of the second score SC2, and the weight of the third score SC3. For example, the weight coefficients α, β, γ are set such that relationships of α + β + γ = 1, 0 < α < 1, 0 < β < 1, and 0 < γ < 1 are satisfied. Any setting values may be used for the weight coefficients α, β, γ.

The access point selection unit 345 acquires the score SC of each access point AP at the target position calculated in this manner. Then, the access point selection unit 345 selects the target access point TAP to which the vehicle 1 at the target position should be connected among the plurality of access points AP based on the score SC. Typically, the access point selection unit 345 selects the access point AP with the highest score SC among the plurality of access points AP as the target access point TAP.

According to the fourth example described above, both the effects by the second example and the effects by the third example can be obtained.

### 3-5. Fifth Example

An example of path determination processing of determining (selecting) an appropriate traveling path TP in terms of communication will be described next. As illustrated in FIG. 5 already described above, the traveling path candidate TPC that is a candidate for the traveling path TP of the vehicle 1 in the predetermined area AR is provided. In particular, a plurality of the traveling path candidates TPC is provided. The plurality of traveling path candidates TPC is, for example, set by the management system 200. When there are a number of possible traveling path candidates TPC to a destination, only traveling path candidates TPC for which distances to the destination are less than a threshold may be selected in advance. An appropriate traveling path TP is selected from the plurality of traveling path candidates TPC.

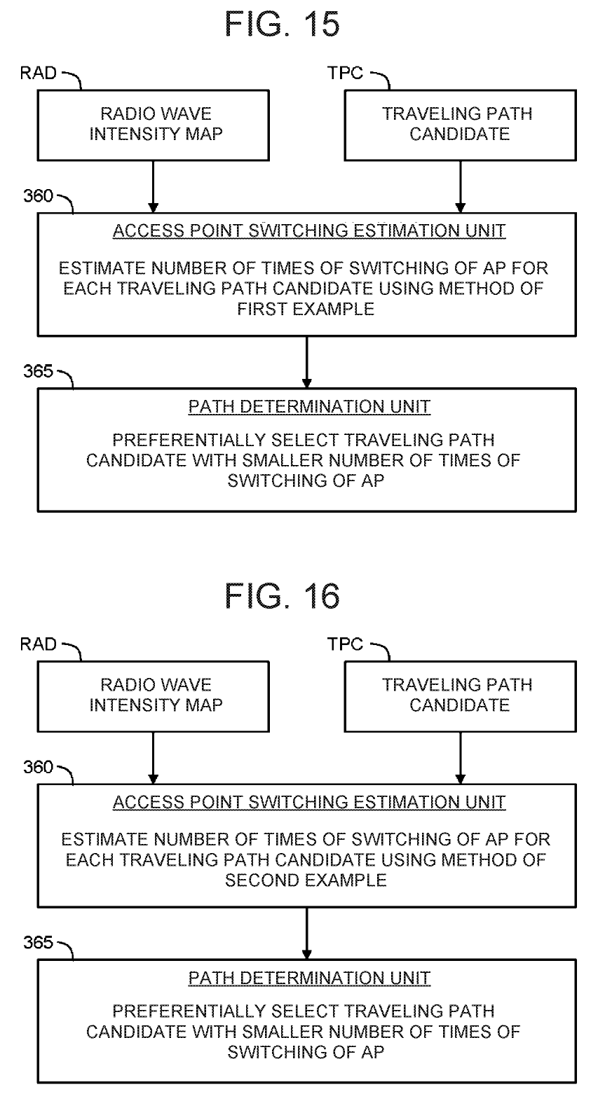

FIG. 15 is a block diagram illustrating a functional configuration example regarding the fifth example of the communication-related processing. The information processing system 300 (path determination system) includes an access point switching estimation unit 350 and a path determination unit 355.

The access point switching estimation unit 350 acquires the radio wave intensity map RAD and the information on the traveling path candidates TPC. The radio wave intensity map RAD is included in the access point management information AMN and can be obtained from the management system 200. The traveling path candidates TPC are also set by the management system 200 and can be obtained from the management system 200. The access point switching estimation unit 350 calculates the number of times of switching of the target access point TAP assuming that the vehicle 1 travels through the traveling path candidate TPC within the predetermined area AR. The number of times of switching of the target access point TAP is calculated for each of the traveling path candidates TPC.

In the fifth example, the target access point TAP is selected using the method described in the above-described first example. In other words, the access point switching estimation unit 350 calculates the score SC of each access point AP at the target position on the traveling path candidate TPC based on the radio wave intensity map RAD and the traveling path candidate TPC in a similar manner to the score calculation unit 310 illustrated in FIG. 7. Further, the access point switching estimation unit 350 selects the target access point TAP to which the vehicle 1 at the target position should be connected among the plurality of access points AP based on the score SC in a similar manner to the access point selection unit 315 illustrated in FIG. 7. Then, the access point switching estimation unit 350 calculates the number of times of switching of the target access point TAP based on transition of the target access point TAP along the traveling path candidate TPC.

The path determination unit 355 acquires the number of times of switching for each of the traveling path candidates TPC calculated in this manner. Then, the path determination unit 355 preferentially determines the traveling path candidate TPC with the smaller number of times of switching of the target access point TAP as the traveling path TP. For example, the path determination unit 355 determines (selects) the traveling path candidate TPC with the smallest number of times of switching of the target access point TAP among the plurality of traveling path candidates TPC as the traveling path TP. Note that the path determination unit 355 may exclude the traveling path candidates TPC for which distances are equal to or longer than a threshold from the traveling path TP.

As described above, according to the fifth example, the traveling path TP is determined such that the number of times of switching of the target access point TAP becomes smaller. The number of times of switching of the target access point TAP becoming smaller is preferable in terms of reduction in risk.

### 3-6. Sixth Example

FIG. 16 is a block diagram illustrating a functional configuration example regarding the sixth example of the communication-related processing. Description overlapping with the description of the above-described fifth example will be omitted as appropriate. The information processing system 300 (path determination system) includes an access point switching estimation unit 360 and a path determination unit 365.

The access point switching estimation unit 360 calculates the number of times of switching of the target access point TAP assuming that the vehicle 1 travels through the traveling path candidate TPC within the predetermined area AR. In the sixth example, the target access point TAP is selected using the method described above in the second example. In other words, the access point switching estimation unit 360 calculates the score SC of each access point AP at the target position on the traveling path candidate TPC based on the radio wave intensity map RAD and the traveling path candidate TPC in a similar manner to the score calculation unit 320 illustrated in FIG. 10. Further, the access point switching estimation unit 360 selects the target access point TAP to which the vehicle 1 at the target position should be connected among the plurality of access points AP based on the score SC in a similar manner to the access point selection unit 325 illustrated in FIG. 10. Then, the access point switching estimation unit 360 calculates the number of times of switching of the target access point TAP based on transition of the target access point TAP along the traveling path candidate TPC.

The path determination unit 365 acquires the number of times of switching for each of the traveling path candidates TPC calculated in this manner. Then, the path determination unit 365 preferentially determines the traveling path candidate TPC with the smaller number of times of switching of the target access point TAP as the traveling path TP. For example, the path determination unit 365 determines (selects) the traveling path candidate TPC with the smallest number of times of switching of the target access point TAP among the plurality of traveling path candidates TPC as the traveling path TP. Note that the path determination unit 365 may exclude the traveling path candidates TPC for which distances are equal to or longer than the threshold from the traveling path TP.

As described above, according to the sixth example, the traveling path TP is determined such that the number of times of switching of the target access point TAP becomes smaller. In particular, according to the sixth example, the number of times of switching of the target access point TAP becomes further smaller than that in the above-described fifth example. The number of times of switching of the target access point TAP becoming smaller is preferable in terms of reduction in risk.

### 3-7. Seventh Example

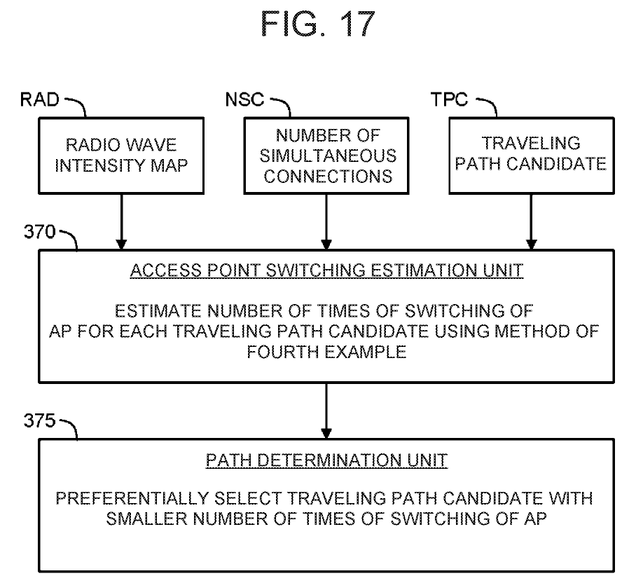

FIG. 17 is a block diagram illustrating a functional configuration example regarding the seventh example of the communication-related processing. Description overlapping with the description of the above-described fifth example will be omitted as appropriate. The information processing system 300 (path determination system) includes an access point switching estimation unit 370 and a path determination unit 375.

The access point switching estimation unit 370 calculates the number of times of switching of the target access point TAP assuming that the vehicle 1 travels through the traveling path candidate TPC within the predetermined area AR. In the seventh example, the target access point TAP is selected using the method described in the above-described fourth example. In other words, the access point switching estimation unit 370 calculates the score SC of each access point AP at the target position on the traveling path candidate TCP based on the radio wave intensity map RAD, the number of simultaneous connections NSC, and the traveling path candidate TPC in a similar manner to the score calculation unit 340 illustrated in FIG. 14. Further, the access point switching estimation unit 370 selects the target access point TAP to which the vehicle 1 at the target position should be connected among the plurality of access points AP based on the score SC in a similar manner to the access point selection unit 345 illustrated in FIG. 14. Then, the access point switching estimation unit 370 calculates the number of times of switching of the target access point TAP based on transition of the target access point TAP along the traveling path candidate TPC.

The path determination unit 375 acquires the number of times of switching for each of the traveling path candidates TPC calculated in this manner. Then, the path determination unit 375 preferentially determines the traveling path candidate TPC with the smaller number of times of switching of the target access point TAP as the traveling path TP. For example, the path determination unit 375 determines (selects) the traveling path candidate TPC with the smallest number of times of switching of the target access point TAP among the plurality of traveling path candidates TPC as the traveling path TP. Note that the path determination unit 375 may exclude the traveling path candidates TPC for which distances are equal to or longer than the threshold from the traveling path TP.

As described above, according to the seventh example, the traveling path TP is determined such that the number of times of switching of the target access point TAP becomes smaller. The number of times of switching of the target access point TAP becoming smaller is preferable in terms of reduction in risk. Further, effects similar to those in a case of the above-described fourth example can be obtained.

### 4. CONFIGURATION EXAMPLE

### 4-1. Configuration Example of In-Vehicle System

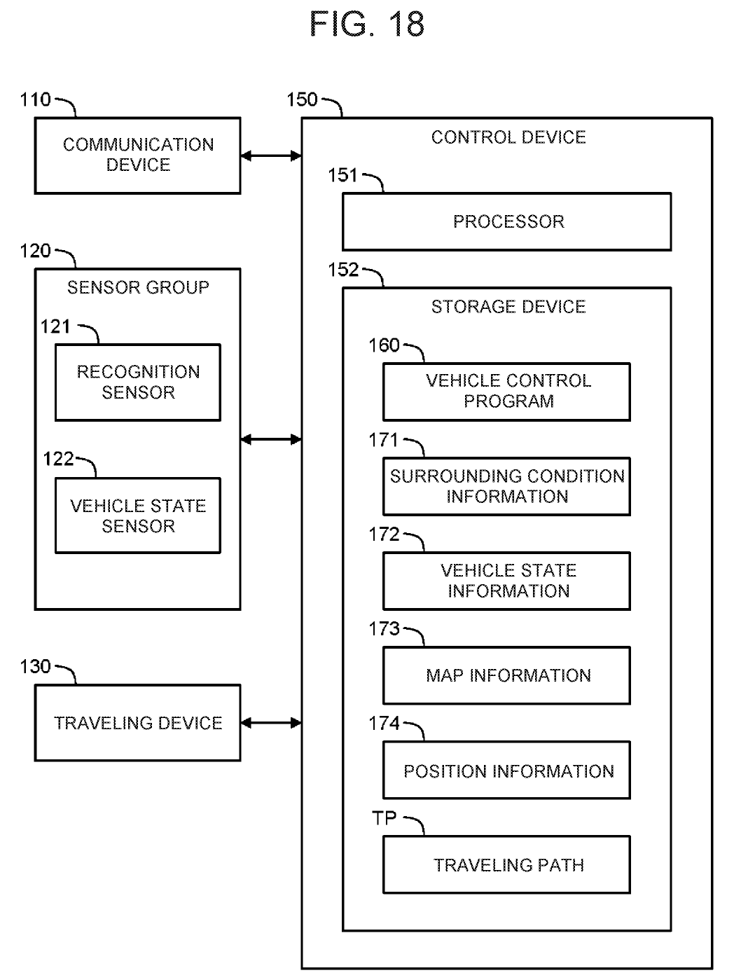

FIG. 18 is a block diagram illustrating a configuration example of the in-vehicle system 100 according to the present embodiment. The in-vehicle system 100 includes a communication device 110, a sensor group 120, a traveling device 130, and a control device 150.

The communication device 110 performs communication with outside via a communication network. For example, the communication device 110 performs communication with the management system 200 in the predetermined area AR via the access point AP of the wireless LAN.

The sensor group 120 includes a recognition sensor 121, a vehicle state sensor 122, and the like. The recognition sensor 121 is utilized to recognize (detect) a condition around the vehicle 1. Examples of the recognition sensor 121 can include a camera, a laser imaging detection and ranging (LIDAR), a radar, and the like. The vehicle state sensor 122 includes a speed sensor, an acceleration sensor, a yaw rate sensor, a steering angle sensor, and the like.

The traveling device 130 includes a steering device, a driving device, and a braking device. The steering device steers wheels. For example, the steering device includes a power steering (electric power steering (EPS)) device. The driving device is a power source for generating driving force. Examples of the driving device can include an engine, an electric motor, an in-wheel motor, and the like. The braking device generates braking force.

The control device 150 is a computer that controls the vehicle 1. The control device 150 includes one or more processors 151 (hereinafter, simply referred to as a processor 151), and one or more storage devices 152 (hereinafter, simply referred to as a storage device 152). The processor 151 executes various kinds of processing. Examples of the processor 151 include a general-purpose processor, an application specific instruction-set processor, a central processing unit (CPU), a graphics processing unit (GPU), an application specific integrated circuit (ASIC), a field-programmable gate array (FPGA), an integrated circuit, and/or a combination thereof. The processor 151 can be also referred to as a processing circuitry. The storage device 152 stores various kinds of information. Examples of the storage device 152 can include a volatile memory, a non-volatile memory, a hard disk drive (HDD), a solid state drive (SSD), and the like.

A vehicle control program 160 is a computer program for controlling the vehicle 1. Functions of the control device 150 may be implemented by coordination of the processor 151 that executes the vehicle control program 160 and the storage device 152. The vehicle control program 160 is stored in the storage device 152. Alternatively, the vehicle control program 160 may be recorded in a computer-readable recording medium.

The control device 150 executes vehicle traveling control of controlling traveling of the vehicle 1. The vehicle traveling control includes steering control, acceleration control, and deceleration control. The control device 150 executes vehicle traveling control by controlling the traveling device 130 (the steering device, the driving device, and the braking device).

The control device 150 acquires various kinds of information. The various kinds of information are stored in the storage device 152.

Surrounding condition information 171 indicates a recognition result by the recognition sensor 121. The surrounding condition information 171 may include object information regarding an object recognized by the recognition sensor 121. Examples of the object around the vehicle 1 can include an obstacle, a white line, a marker M, and the like. Examples of the obstacle can include a wall, a pillar, other vehicles, and the like. The object information indicates a position and a speed of the object relative to the vehicle 1.

Vehicle state information 172 indicates a vehicle state detected by the vehicle state sensor 122.

Map information 173 is map information of the predetermined area AR in which the vehicle 1 travels. The map information 173 indicates arrangement of roads within the predetermined area AR. Further, the map information 173 indicates arrangement of stationary obstacles (for example, a wall, a pillar) within the predetermined area AR. Still further, the map information 173 indicates arrangement of the markers M within the predetermined area AR. For example, the map information 173 is provided from the management system 200 that manages the predetermined area AR. The control device 150 acquires the map information 173 from the management system 200 via the communication device 110.

Position information 174 indicates a current position of the vehicle 1 in the predetermined area AR. For example, the control device 150 acquires the high-accuracy position information 174 by localization processing. Specifically, the control device 150 calculates a rough position of the vehicle 1 in the predetermined area AR based on the vehicle state information 172 (the steering angle and the speed). Further, the control device 150 recognizes the markers M around the vehicle 1 using the recognition sensor 121. Still further, the control device 150 acquires arrangement information of the markers M around the vehicle 1 from the map information 173. The control device 150 corrects the position of the vehicle 1 by matching the recognition result of the markers M and the arrangement. By this means, the high-accuracy position information 174 can be obtained.

Alternatively, the position information 174 of the vehicle 1 may be estimated by the management system 200 based on the image captured by the infrastructure camera CAM. In this case, the control device 150 may acquire the position information 174 from the management system 200 via the communication device 110.

Further, the control device 150 acquires information on the traveling path TP in the predetermined area AR. For example, the management system 200 determines the traveling path TP, and the control device 150 acquires the information on the traveling path TP from the management system 200 via the communication device 110. As another example, the control device 150 may determine the traveling path TP based on the map information 173 and the position information 174. Then, the control device 150 executes vehicle traveling control such that the vehicle 1 travels in accordance with the traveling path TP based on the position information 174.

### 4-2. Configuration Example of Management System

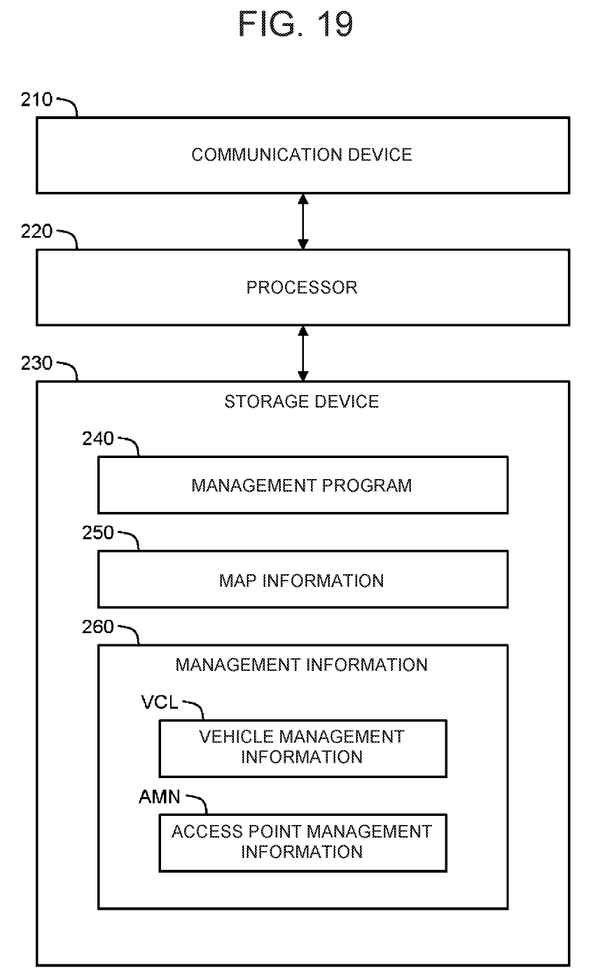

FIG. 19 is a block diagram illustrating a configuration example of the management system 200 according to the present embodiment. The management system 200 includes a communication device 210, one or more processors 220 (hereinafter, simply referred to as a processor 220), and one or more storage devices 230 (hereinafter, simply referred to as a storage device 230).

The communication device 210 performs communication with the in-vehicle system 100 of each vehicle 1. The communication device 210 may perform communication with the infrastructure camera CAM provided in the predetermined area AR. The communication device 210 may perform communication with the access point AP provided in the predetermined area AR.

The processor 220 executes various kinds of processing. Examples of the processor 220 can include a general-purpose processor, an application specific instruction-set processor, a CPU, a GPU, an ASIC, an FPGA, an integrated circuit and/or a combination thereof. The processor 220 can be also referred to as a processing circuitry. The storage device 230 stores various kinds of information. Examples of the storage device 230 can include a volatile memory, a non-volatile memory, an HDD, an SSD, and the like.

A management program 240 is a computer program for managing the predetermined area AR. Functions of the management system 200 may be implemented by coordination of the processor 220 that executes the management program 240 and the storage device 230. The management program 240 is stored in the storage device 230. The management program 240 may be recorded in a computer-readable recording medium.

The storage device 230 stores map information 250 of the predetermined area AR. The map information 250 is similar to the map information 173 described above. The processor 220 may provide the map information 250 to the in-vehicle system 100 via the communication device 210.

Further, the storage device 230 stores management information 260 for managing the predetermined area AR. For example, when the predetermined area AR is the parking lot PL, the management information 260 indicates use conditions (availabilities) of parking spaces within the parking lot PL. The processor 220 can allocate an available parking space (destination) to the vehicle 1 based on the management information 260.

The management information 260 may include vehicle management information VCL for managing the vehicle 1 within the predetermined area AR. The vehicle management information VCL includes the position information 174 of each vehicle 1 within the predetermined area AR. The processor 220 may perform communication with each vehicle 1 via the communication device 210 to collect the position information 174 from each vehicle 1. Alternatively, the processor 220 may acquire an image captured by the infrastructure camera CAM provided in the predetermined area AR and estimate the position of each vehicle 1 based on the image.

The vehicle management information VCL may include the traveling path TP to be allocated to each vehicle 1 and the traveling path candidate TPC. The processor 220 can determine the traveling path TP to be allocated to each vehicle 1 based on the position information 174 of the vehicle 1, a destination, and the map information 250. The processor 220 may provide the information on the traveling path TP to the in-vehicle system 100 of the vehicle 1 via the communication device 210. This similarly applies to the traveling path candidate TPC.

Further, the management information 260 includes access point management information AMN for managing the access points AP within the predetermined area AR.

The access point management information AMN includes the radio wave intensity map RAD (se FIG. 2). The radio wave intensity map RAD includes information on a radio wave intensity distribution of each of the plurality of access points AP within the predetermined area AR. As described above, the information on the radio wave intensity distribution may be static or dynamic. The vehicle management information described above includes the position information 174 (current position) of each vehicle 1 within the predetermined area AR. By taking into account the position information 174 (current position) of each vehicle 1 within the predetermined area AR, it is possible to calculate a dynamic radio wave intensity distribution for each access point AP in real time.

The access point management information AMN may include the number of simultaneous connections NSC to each of the plurality of access points AP within the predetermined area AR (see FIG. 2). For example, the processor 220 performs communication with each access point AP via the communication device 210 to acquire information on the number of simultaneous connections NSC from each access point AP in real time.

### 4-3. Configuration Example of Information Processing System

The information processing system 300 is applied to the vehicle 1 and executes the communication-related processing. For example, the information processing system 300 is included in the in-vehicle system 100. As another example, the information processing system 300 may be included in the management system 200. As still another example, the information processing system 300 may be distributed into the in-vehicle system 100 and the management system 200. As yet another example, the information processing system 300 may be a system which is different from but can perform communication with the in-vehicle system 100 and the management system 200. In either case, the in-vehicle system 100, the management system 200, and the information processing system 300 are configured to be able to share the same information.

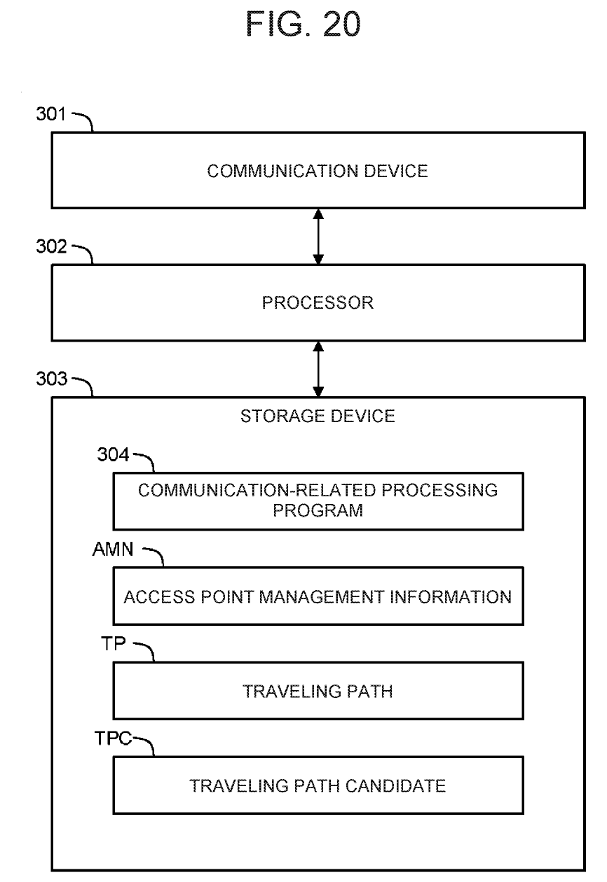

FIG. 20 is a block diagram illustrating a configuration example of the information processing system 300 according to the present embodiment. The information processing system 300 includes a communication device 301, one or more processors 302 (hereinafter, simply referred to as a processor 302), and one or more storage devices 303 (hereinafter, simply referred to as a storage device 303).

The communication device 301 performs communication with outside of the information processing system 300. The communication device 301 may be included in the communication device 110 of the in-vehicle system 100. The communication device 301 may be included in the communication device 210 of the management system 200.

The processor 302 executes various kinds of processing. Examples of the processor 302 include a general-purpose processor, an application specific instruction-set processor, a CPU, a GPU, an ASIC, an FPGA, an integrated circuit, and/or a combination thereof. The processor 302 can be also referred to as a processing circuitry. The processor 302 may be included in the processor 151 of the in-vehicle system 100. The processor 302 may be included in the processor 220 of the management system 200.

The storage device 303 stores various kinds of information. Examples of the storage device 303 can include a volatile memory, a non-volatile memory, an HDD, an SSD, and the like. The storage device 303 may be included in the storage device 152 of the in-vehicle system 100. The storage device 303 may be included in the storage device 230 of the management system 200.

A communication-related processing program 304 is a computer program for executing the communication-related processing. The communication-related processing program 304 can be also referred to as a communication control program of executing the communication-related processing. The communication-related processing program 304 can be also referred to as a path determination program of executing path determination processing. Functions of the information processing system 300 may be implemented by coordination of the processor 302 that executes the communication-related processing program 304 and the storage device 303. The communication-related processing program 304 is stored in the storage device 303. The communication-related processing program 304 may be recorded in a computer-readable recording medium.

The processor 302 acquires the access point management information AMN from the management system 200. Further, the processor 302 acquires the information on the traveling path TP and the traveling path candidate TPC from the management system 200. The access point management information AMN, and the information on the traveling path TP and the traveling path candidate TPC are stored in the storage device 303. The processor 302 executes the communication-related processing described above in section 2 and section 3 based on the access point management information AMN, the traveling path TP and the traveling path candidate TPC.

What is claimed is:

1. A communication control system to be applied to a vehicle that travels in a predetermined area in which a plurality of access points is provided, the communication control system comprising:
one or more processors; wherein:
the one or more processors are configured to:
acquire information on a radio wave intensity distribution of each of the plurality of access points;
acquire information on a traveling path of the vehicle in the predetermined area;
calculate a score of each of the access points at a target position on the traveling path based on the acquired information on the radio wave intensity distribution and the acquired information on the traveling path; and
select a target access point to which the vehicle at the target position is to be connected among the plurality of access points based on the calculated score of each of the access points;
the calculated score of each of the access points includes at least a first score and a second score;
the first score becomes higher as radio wave intensity at the target position becomes stronger; and
the second score becomes higher as continuity of an upward trend of radio wave intensity along the traveling path beyond the target position becomes higher.

2. The communication control system according to claim 1, wherein:
a first position is a position located a first distance ahead of the target position along the traveling path;
a determination range is a range between the target position and the first position along the traveling path;
an upward trend distance is a sum of distances during which the upward trend of the radio wave intensity continues in the determination range; and
as the upward trend distance or a ratio of the upward trend distance with respect to the first distance increases, the continuity of the upward trend becomes higher.

3. The communication control system according to claim 1, wherein the one or more processors acquire the information on the radio wave intensity distribution of each of the access points from a management system that manages the predetermined area.

4. The communication control system according to claim 1, wherein the radio wave intensity distribution of each of the access points is a static radio wave intensity distribution determined based on a position at which each of the access points is provided and performance of each of the access points.

5. The communication control system according to claim 1, wherein the radio wave intensity distribution of each of the access points is a dynamic radio wave intensity distribution calculated based on a distribution of moving bodies in the predetermined area in addition to a position at which each of the access points is provided and performance of each of the access points.

6. The communication control system according to claim 1, wherein:
the one or more processors are further configured to:
acquire information on the number of simultaneous connections of each of the access points; and
calculate the score of each of the access points at the target position on the traveling path based on the acquired information of the radio wave intensity distribution, the acquired information on the traveling path, and the acquired information on the number of simultaneous connections; and
the calculated score of each of the access points further includes a third score that becomes higher as the number of simultaneous connections becomes smaller.

7. The communication control system according to claim 1, wherein:
the predetermined area is a parking lot; and
the vehicle includes a function of automated valet parking.

8. A communication control method to be executed by a computer and to be applied to a vehicle that travels in a predetermined area in which a plurality of access points is provided,
the communication control method comprising:
acquiring information on a radio wave intensity distribution of each of the plurality of access points;
acquiring information on a traveling path of the vehicle in the predetermined area;
calculating a score of each of the access points at a target position on the traveling path based on the acquired information on the radio wave intensity distribution and the acquired information on the traveling path; and
selecting a target access point to which the vehicle at the target position is to be connected among the plurality of access points based on the calculated score of each of the access points, wherein:
the calculated score of each of the access points includes at least a first score and a second score;
the first score becomes higher as radio wave intensity at the target position becomes stronger; and
the second score becomes higher as continuity of an upward trend of radio wave intensity along the traveling path beyond the target position becomes higher.

9. A non-transitory storage medium storing instructions that are executable by one or more processors and that cause the one or more processors to perform functions comprising:
acquiring information on a radio wave intensity distribution of each of a plurality of access points;
acquiring information on a traveling path of a vehicle in the predetermined area;
calculating a score of each of the access points at a target position on the traveling path based on the acquired information on the radio wave intensity distribution and the acquired information on the traveling path; and
selecting a target access point to which the vehicle at the target position is to be connected among the plurality of access points based on the calculated score of each of the access points, wherein:
the calculated score of each of the access points includes at least a first score and a second score;
the first score becomes higher as radio wave intensity at the target position becomes stronger; and
the second score becomes higher as continuity of an upward trend of radio wave intensity along the traveling path beyond the target position becomes higher.
